(19) United States
(12) Patent Application Publication
(10) Pub. No.: US 2017/0052069 A1
(43) Pub. Date: Feb. 23, 2017

(54) METHOD FOR DETERMINING THE TEMPERATURE OF AN INFRARED-ACTIVE GAS BY MEANS OF INFRARED SPECTROSCOPY

(71) Applicant: HUMEDICS GMBH, Berlin (DE)

(72) Inventors: Tom RUBIN, Berlin (DE); Karsten HEYNE, Beelitz (DE)

(73) Assignee: HUMEDICS GMBH, Berlin (DE)

(21) Appl. No.: 15/307,344

(22) PCT Filed: Apr. 28, 2015
(86) PCT No.: PCT/EP2015/059195

§ 371 Date: Oct. 27, 2016

(30) Foreign Application Priority Data
Apr. 29, 2014 (EP) 14166357.5

(51) Int. Cl. G01J 5/00; G01J 5/10; G01N 21/3504

(52) U.S. Cl. CPC G01J 5/0014; G01N 21/3504; G01J 5/10; G01N 2201/12; G01N 2201/06113

(57) ABSTRACT

A method for determining the temperature of an infrared-active gas by means of infrared spectroscopy is provided. The method comprising: radiating infrared light in a spectral range of 700 cm⁻¹ to 5000 cm⁻¹ originating from an infrared light source onto the gas; obtaining a first absorption-related parameter originating from measuring a first infrared absorption band of the gas, wherein the first infrared absorption band is a hot band being caused by thermal population of at least one vibrational mode of the gas; obtaining a second absorption-related parameter originating from measuring a second infrared absorption band of the gas, and calculating a ratio between the first absorption-related parameter and the second absorption-related parameter. The method is characterized in that the ratio is used to determine the temperature of the gas, wherein the ratio has a relative change of at least 0.5% per Kelvin temperature difference of the gas.

### CROSS-REFERENCE TO A RELATED APPLICATION

This application is a National Phase Patent Application of International Patent Application Number PCT/EP2015/059195, filed on Apr. 28, 2015, which claims priority of European Patent Application Number 14166357.5, filed on Apr. 29, 2014.

### BACKGROUND

The instant invention relates to a method for determining the temperature of an infrared-active gas by means of infrared spectroscopy.

Rotational transitions and rotation-vibration transitions are very sensitive to temperature. This is due to the fact that the relative energy difference between adjacent rotational energy levels is in the order of some wavenumbers. According to equation 1, at room temperature the energy is about 204 cm⁻¹, enough to populate a number of higher rotational states.

$${k}_{B} {T}_{T = 293 K} \approx \frac{1}{40} eV \approx 204 {cm}^{- 1} \qquad Equation 1$$

The rotational and rotation-vibrational spectrum is generally divided into three rotational transition branches, namely the R-branch, the P-branch, and the Q-branch. In the following, infrared absorption spectra of CO₂ will be discussed as example. Upon excitation of the asymmetric stretching vibration of CO₂ rotational transitions couple to this excitation, reflected by the selection rules. FIG. 1 show a section of a mid-infrared absorption spectrum of CO₂, wherein the R-branch and the P-branch of the asymmetric stretching transition are specifically marked. Either branch represents an absorption band series comprising several absorption bands.

On the high energy side, the R-branch of ¹²CO₂, and on the low energy side, the P-branch of ¹²CO₂ as well as the P-branch of ¹³CO₂ at even lower energies can be seen. In the range of 2300 cm⁻¹ the R-branch of ¹³CO₂ and the P-branch of ¹²CO₂ overlap. In this spectral region both ¹²CO₂ and ¹³CO₂ can be measured simultaneously within the same spectral range and similar absorption strengths.

The R-branch (J→J+1) and the P-branch (J→J−1) couple to the vibrational transition v=0→1. The dip in the middle of the two ¹²CO₂ branches is related to the energy difference Δv̅=v̅₁−v̅₀=2349 cm⁻¹ of a vibrational transition of ¹²CO₂. The analogue energy for ¹³CO₂ has a value of 2282 cm⁻¹.

As mentioned above, the absorption spectrum of rotational and rotation-vibrational transitions is highly temperature dependent, since the population number N of a given state K (or J) as compared to the ground state K=0 is given by the following equation 2:

$$\frac{{N}_{K}}{{N}_{0}} = \frac{{g}_{K}}{{g}_{0}} {e}^{- ( {E}_{K} - {E}_{0} ) / ( {k}_{B} T )} = ( 2 K + 1 ) {e}^{- BhcK ( K + 1 ) / ( {k}_{B} T )} \qquad Equation 2$$

Thereby, (2K+1) is the degeneracy of rotational levels, K is the rotational level and B is the rotational constant of the molecule (for the asymmetric stretching of CO₂ B is approximately 0.39 cm⁻¹).

Since the temperature is a part of the exponential function in equation 2, the influence is very strong. The rotational constant B for the asymmetric stretching of CO₂ can be found in the HITRAN Database (available under the address http://www.cfa.harvard.edu/hitran/) or can be determined directly as presented in FIG. 2 which shows spectral positions of the rotation-vibration absorption maxima as a function of K. The solid line of FIG. 2 is a polynomial fit to second order with the following coefficients: A₀=2349.71±0.04, A₁=−0.781±0.004, A₂=−0.00293±0.0007. The value A₁=(0.781±0.004) represents two times B, due to symmetry reasons resulting in selection rules for odd and even rotation quantum numbers. Thus, from the spectral positions the rotational constant can be determined to be B=(0.3905±0.002). Selection rules, spectral positions and the physical basis for these properties are explained in the book of G. Herzberg (G. Herzberg. Infrared and Raman Spectra. Van Nostrand Reinhold Company, 1945).

With the known rotational constant, the intensity distribution of the rotation-vibrational absorption peaks can be simulated. Such a simulation is depicted in FIG. 3, showing the temperature dependence of the R-branch of the rotation-vibrational absorption spectrum of the CO₂ asymmetric stretching. The ground state intensity is one. As the temperature increases, the higher rotational level become more populated, leading to a change in the shape of the series of absorption peaks. The envelope of the absorption peaks exhibits a maximum intensity I(Kₘₐₓ) at a specific rotational state.

This maximum Kₘₐₓ can also be calculated according to equation 3:

$${K}_{max} = \sqrt{\frac{{k}_{B} T}{2 hcB} - \frac{1}{2}} \qquad Equation 3$$

The maximum Kₘₐₓ is dependent on the temperature. This indicates that the population change of the rotational levels and also the intensities of the peaks in the absorption spectrum alter as a function of temperature.

In order to determine the temperature or the temperature change from the absorption lines, it is useful to identify those absorption lines with the maximal absorption change at a given temperature. This can be determined by setting the second derivative of the following equation 4 as zero:

$$\frac{{d}^{2}}{d {K}^{2}} ( {N}_{K} ) = \frac{{d}^{2}}{d {K}^{2}} ( ( 2 K + 1 ) {e}^{\frac{BhcK ( K + 1 )}{{k}_{B} T}} ) = 0 \qquad Equation 4$$

This leads to a maximal change for K_{wm} that can be calculated according to the following equation 5

$${K}_{wm} = \sqrt{\frac{3 {k}_{B} T}{2 Bhc}} - \frac{1}{2} \qquad Equation 5$$

At room temperature (25° C.) the maximal change can be observed at K_{wm}˜28-29(h=6.626*10⁻³⁴ Js; c=3*10⁸ m/s; k_{B}=1.3806*10⁻²³ J/K, B=38.71 m⁻¹, T=298.15 K).

The change that can be observed upon a temperature change from 40.0° C. to 40.1° C. is depicted in FIG. 4 showing the intensity difference at different rotational quantum numbers of the asymmetric stretching vibration of CO₂ between temperatures of 40.0° C. and 40.1° C.

The maximal signal change at a temperature difference of ΔT=0.1° C. is 0.006. Since the signal intensity is about 20 (in relative units), the relative signal change is around 0.3‰. If the signal has an absorbance of 1 optical density (OD), the signal change is around 0.3 mOD. Additionally, it is visible in FIG. 4 that adjacent rotational quantum numbers with similar enough absorption show a similar temperature dependence. It was reported by Arroyo et al. that for temperature determination two vibrational lines should have similar enough absorption (Arroyo, M. P., et al. Applied Optics (1994), 33:15, 3296-3307). Although they used near infrared spectroscopy at vibrational transitions, this should also hold for infrared spectroscopy and rotation-vibrational transitions.

Infrared spectroscopy was used by Jellison et al. (Jellison, G. P, et al.; Proc. of SPIE (2004), Vol. 5425, 244-255) and they found best suited wavelengths of 4.19668 μm and 14.5023 μm, corresponding to J values of 56 and 26 of the asymmetric stretching and bending vibrations, respectively. Upon a single scan time of 16 seconds they reported a temperature determination with a root-mean square error of 24K. This is in line with a normal temperature dependence of rotation-vibrational transitions increasing with temperature. Thus, the ratio of the two absorption lines will change only to a small extent. This is state-of-the-art and depicted in FIG. 4.

If one would measure two lines of J˜30 and J′˜40, the absorption lines would exhibit relative strengths of 8 and 3, being similar enough to achieve a rather good detection sensitivity of the lines (see Arroyo). The change of the absorption ratios upon ΔT of 1 K would decrease from 8/3 to 8.0062/3.0045, resulting in a ratio alteration of 1.9‰. These absorbance changes are too small to be detected with pure infrared spectroscopy that is typically limited to 1% changes. This spectroscopic precision of 1% is also supported by Arroyo et al., and is an experimental value for absorption spectroscopy containing reproducibility problems, noise, systematic noise, systematic errors, pressure dependence, temperature stability, pointing stabilities, spectral resolution, linewidth changes, etc.

In an application for fast temperature determination of gas, air or breath samples the temperature has to be determined faster than the temperature changes in the sample. Especially, determination of a flowing gas that is not stored in a sample cell, i.e. a gas volume that is not limited at two ends of its direction of propagation, has to be measured on a time scale faster than its propagation velocity. In the situation of a flowing gas with changing temperature and concentration the measurement of temperature and concentration may not be performed sequentially, in order to acquire accurate results. This means the temperature determination and concentration determination have to be performed at the same time and place. Such a measurement is a multi-parallel measurement. If the multi-parallel measurement is finished in a time window faster than 1% change of temperature and/or concentration it is a real-time measurement. If the gas is continuously changing in temperature or concentration and is detected by the multi-parallel measurement, then the detection is continuously.

In contrast, a sequential measurement procedure as for example described in Stepanov et al. by (i) evacuating a sample cell, (ii) filling the sample cell, (iii) performing the measurement, and starting again with point (i), is not a continuous measurement (Stepanov, E. V, et al.; Optical Engineering; (1993), 32:2, 361-367).

In case of measurements of exhaled breath in which the breath is not homogenized at all, there are at least four to ten precise temperature measurements necessary within 2 seconds to follow the change of the temperature of the individual breath sample. Depending on the precision of a single measurement the number of measurements has to be increased within the same time period to enhance the statistics to acquire the necessary precision.

This becomes evident from a concentration change of CO₂ during a single breath. The course of CO₂ absorption in exhaled breath of two consecutive breaths is shown in FIG. 5. The increasing concentration of CO₂ is proportional to the increasing temperature during a breath.

From the absorption intensity of the absorption peaks the temperature can only be determined, if the number of measured molecules is exactly known, or if the sample concentration and thickness is exactly known. In case of breath measurements or measurements of flowing air this is typically not the case with a precision of better than 1% at any time. Therefore, additional ways have to be found to determine the amount of molecules and the temperature in the (strongly) fluctuating gas sample simultaneously, or within a time period in which these changes can be neglected.

One could try to determine the temperature of an unknown gas sample by evaluating two adjacent infrared absorption peaks. Assume the temperature of the gas sample contains CO₂ and two adjacent CO₂ absorption peak signals with rotational quantum numbers J=28 and J=30 were measured (cf. FIG. 4; these rotational quantum numbers are the numbers for which the highest temperature dependent intensity changes of the underlying infrared absorption band could be determined). The Lambert-Beer Law according to equation 6 connects the absorption signal A_{J} with the original intensity I₀ and the transmitted intensity I after the infrared radiation passed through the sample.

$${A}_{J} = - log ( \frac{I}{{I}_{0}} ) = - {ɛc}_{J} d \qquad Equation 6$$

The extinction coefficient ε is constant within the same series of rotation-vibration transitions, d is the thickness of the sample and c_{J} is the concentration of the molecules with quantum number J.

Here, the explanation is restricted to rotation-vibrational transitions with energy differences much higher than 204 cm⁻¹ (observed at room temperature as explained above) so that induced emission and reduced excitation cross sections due to populations in the higher excited states can be neglected. Nevertheless, these considerations can equally be used for rotational transitions and transitions of lower energies.

The concentration of the gas molecules can be divided in subsamples with different rotational quantum numbers J. These subsamples have the concentration c_{J}. The concentration distributions of these subsamples are given by equation 7:

$${c}_{J} ( T ) = ( 2 J + 1 ) {e}^{- {J ( J + 1 )}^{Bhc / {k}_{B} T}} = ( 2 J + 1 ) {e}^{- \frac{E}{{k}_{B} T}} \qquad Equation 7$$

If one measures the absorption signal spectrally resolved, the area under the absorption line width function is directly the absorption signal. The peak height of the absorption line can be modulated by line broadening due to changing pressure, gas composition, or other effects. Measuring the absorption line in a spectrally resolved manner provides the most accurate results.

For a single absorption line or absorption peak the signal variations upon temperature change can be calculated according to equation 8:

$$\begin{matrix}{A}_{J , T 0} - {A}_{J , T 1} = Δ {A}_{J , Δ T} \\ = ɛ c \frac{d}{{c}_{Jges}} ( 2 J + 1 ) ⌈ {e}^{- \frac{E}{{k}_{B} {T}_{0}}} - {e}^{- \frac{E}{{k}_{B} {T}_{1}}} ⌉\end{matrix} \qquad Equation 8$$

With a Taylor expansion the following equation 9 can be obtained from equation 8:

$$Δ {A}_{J , Δ T} \approx ɛ c \frac{d}{{c}_{Jges}} ( 2 J + 1 ) {e}^{\frac{E}{{k}_{B} {T}_{0}}} ⌈ 1 + \frac{2 E}{{k}_{B} {T}_{0}^{2}} Δ T + {β ( Δ T )}^{2} + … ⌉ \qquad Equation 9$$

Thereby, the total concentration c_{J, ges} is dependent from the temperature T and the rotational quantum number J according to equation 10:

$${c}_{J , ges} = {\sum }_{0}^{∞} {c}_{j} ( T ) \qquad Equation 10$$

The equations above indicate that the absorption change is direct proportional to the total concentration change c. Small concentration changes of some percent will change the absorption signal linearly. Thus, concentration changes dominate the absorption signal changes, and temperature variations play only a minor role (within reasonable limits).

Therefore, in prior art it is essential to first determine the total concentration c as precise as possible if one intends to determine the temperature of the measured sample gas or to detect temperature changes. This can be done by determination of two absorption peaks of the same molecules (e.g. CO₂) in the same volume at the same time or in the same time period, when temperature and concentration are constant during the measurement. Given this condition the concentration and temperature have to be constant, and at least two measurements are necessary to determine the temperature and/or concentration.

One way to perform such a measurement is to determine the absorption peaks of a gas with two different rotational quantum numbers J. As an example one could use CO₂ with rotational quantum numbers J=28 and J=30. By scanning the spectral region of both adjacent absorption lines, the absorption of A_{J=28} and A_{J=30} are determined at the total CO₂ concentration c and temperature T.

The ratio of the two signals can be calculated according to equation 11:

$$\frac{{A}_{28}}{{A}_{30}} = \frac{2 * 28 + 1}{2 * 30 + 1} {e}^{- \frac{{E}_{28} - {E}_{30}}{{k}_{B} T}} \qquad Equation 11$$

This ratio does not depend on the concentration anymore, because for both absorption peaks A_{J=28} and A_{J=30} the concentration is the same and the ratio solely follows a temperature dependence.

The temperature of the sample gas can then be calculated according to equation 12:

$$T = - \frac{Bhc / {k}_{B} [ J ( J + 1 ) - {J}^{′} ( {J}^{′} + 1 ) ]}{ln ( \frac{{A}_{J}}{{A}_{{J}^{′}}} \frac{2 {J}^{′} + 1}{2 J + 1} )} = - \frac{0.55735 K ( 812 - 930 )}{ln ( \frac{{A}_{J}}{{A}_{{J}^{′}}} \frac{61}{57} )} \qquad Equation 12$$

At a temperature of 40° C. one would get a ratio of A_{J}/A_{J′} of 1.152802, and at a temperature of 40.1° C. one would get a ratio of 1.152725. This corresponds to a relative change of ˜7*10⁻⁵, and 1° C. would result in a relative change of ˜7*10⁻⁴.

### SUMMARY

Such a precision is, if at all, very difficult to obtain using prior art measuring techniques. Thus, there is a need for a novel method to precisely measure the temperature of a sample gas by infrared spectroscopy. It is an object of the instant invention to address this need.

This object is achieved by a method having the features as described herein. Such a method for determining the temperature of an infrared-active gas by means of infrared spectroscopy of rotation-vibrational band transitions comprises the subsequently described steps. First, infrared light originating from an infrared light source of 700 cm⁻¹ to 5000 cm⁻¹ is radiated onto the gas. Then, a first absorption-related parameter is obtained by (or originating from) measuring a first infrared absorption band of the gas, the first infrared absorption band is a hot band being caused by thermal population of a vibrational mode of the gas. At the same time or subsequently, a second absorption-related parameter is obtained by (or originating from) measuring a second infrared absorption band of the gas. Afterwards, a ratio between the first absorption-related parameter and the second absorption-related parameter is calculated.

This method is characterized in that the ratio is used to determine the temperature of the gas, wherein the first absorption band (the hot band) and the second absorption band are chosen such that the ratio has a relative change of at least 0.5% per Kelvin temperature difference of the gas.

In an embodiment, the relative change of the ratio is at least 1% per Kelvin temperature difference of the gas, in particular at least 2% per Kelvin temperature difference of the gas, in particular 3% per Kelvin temperature difference of the gas, in particular 5% per Kelvin temperature difference of the gas, in particular 10% per Kelvin temperature difference of the gas, in particular 15% per Kelvin temperature difference of the gas, in particular 20% per Kelvin temperature difference of the gas. In an embodiment, the relative change of the ratio per Kelvin temperature difference of the gas lies in a range of 0.5% to 25% or within a range built up from any of the before-mentioned percentages (e.g., 1% to 20% etc.).

In an embodiment, the first absorption band has a super-temperature dependence whereas the second absorption band has an anti-temperature dependence.

In the following, the term “temperature dependence” is defined: The temperature dependence and the population of a rotation-vibrational transition is governed by the Boltzmann distribution. Since the change of absorption is instantly used to determine the temperature by the ratio of absorptions, the temperature dependence of an individual absorption band is given by the ratio of the absorption at different temperatures (i.e. the quotient between an absorption at a first temperature and the same absorption at a second temperature). The change of this ratio is the relative temperature dependence. As an example two rotation-vibrational absorption bands A and B are chosen in the following.

For A (¹²CO₂) the rotational quantum number is J=26, and the bending vibrational quantum number v_{B}=2. Note, this is a hot band. The absorption is induced by a transition from the stretching vibration with quantum number v_{S}=0 to v_{S}=1, thereby the rotational quantum number is decreased (P-branch). The energy of this transition is E=1610.01360 cm⁻. At a temperature of T=300 K the population is N(300 K)=α exp(−(h c E)/(k_{B} T)=α*4.39*10⁻⁴. The factor α is a constant for the same rotational quantum number of J=26 derived from equation 2. At a temperature of T=301 K the population is N(301 K)=α*4.52*10⁻⁴. The relative change of absorptions, given by the ratio of N(300 K)/N(301 K)=0.971, has a value of about 3%. This relative change is very big and well measureable by single absorption measurements.

In contrast for B (¹³CO₂) the rotational quantum number is J=26, and the bending vibrational quantum number v_{B}=0. This is a normal rotation-vibrational band. The absorption is induced by a transition from the stretching vibration with quantum number v_{S}=0 to v_{S}=1, thereby the rotational quantum number is increased (R-branch). The energy of this transition is E=273.88100 cm⁻¹. At a temperature of T=300 K the population is N(300 K)=α exp(−(h c E)/(k_{B} T)=α*0.2685. The factor α is a constant for the same rotational quantum number of J=26 derived from equation 2. At a temperature of T=301 K the population is N (301 K)=α*0.26972. The relative change of absorptions, given by the ratio of N(300 K)/N(301 K)=0.995, has a value of about 5‰.

Hence, this example shows a normal rotation-vibrational transition (with a high temperature dependence cp. FIG. 4) with a much higher population than the hot band, but with a normal temperature dependence, in contrast to the hot band with a super-temperature dependence.

A super-temperature dependence (hot band) is a temperature dependence with a stronger temperature dependence than normal rotation-vibrational transitions at same J level. More specifically, a super-temperature dependence is given if the relative change in absorption, of a single absorption band is at least 0.8*10⁻², in particular at least 1*10⁻², in particular at least 1.5*10⁻², in particular at least 2*10⁻², in particular at least 2.5*10⁻², in particular at least 5*10⁻². In an embodiment, a super-temperature dependence is given if the relative change in absorption of the single absorption band is in a range of between 0.8*10⁻² to 5*10⁻² or any other range that can be built up from the before-mentioned minimum relative changes (e.g., 0.8*10⁻² to 5*10⁻², etc.).

As an example, the relative temperature dependence of the (J, v_{strech})−>(J+1, v_{strech}+1) transition of CO₂ for molecules with a thermal population of two bending vibrations is much stronger than the relative temperature dependence for molecules without thermal population of the bending vibrations. The transition changes the asymmetric stretching vibration of CO₂ from 0 to 1 and changes the rotational quantum number from J to J+1, but leaves the bending vibrations unchanged. However, molecules with populated bending vibrations (e.g. hot absorption band at 2301.81 cm⁻¹ and E=hc*1610.0136 cm⁻¹) show an up to hundred times stronger relative absorption increase than without populated bending vibrations (normal absorption bands).

In case of super-temperature dependence, the absorption of a specific absorption band increases with increasing temperature.

In contrast, in case of anti-temperature dependence, the absorption of a specific absorption band decreases with increasing temperature.

Anti-temperature dependence can be observed in normal absorption bands of rotation-vibrational transitions at low or zero rotational quantum numbers. Increasing the temperature leads to thermal population of higher rotational quantum numbers by reducing the population of low rotational quantum numbers. These low rotational quantum numbers exhibit a decrease of population upon thermal population, and thus an anti-temperature dependence. The redistribution of the population is governed by the Boltzmann distribution.

In doing so, both temperature changes as well as the temperature itself can be detected much faster and more precise than according to prior art techniques. The ratio can be used to be multiplied with a factor that is specific for the analyzed gas and for the chosen absorption bands and that can be determined by simple calibration measurements or that can be calculated from artificial (calculated) spectra. The result of this mathematic operation is the temperature of the gas.

The method can be equally used for pure gases and for specific gases contained in a gas mixture.

As outlined above, the first infrared absorption band of the guests is caused by a hot band, i.e. a thermally populated hot state, in which due to thermal population a vibrational mode is excited.

There are different definitions of hot bands in the literature. Jellison et al. defines a hot band by the simple property that the lower energy state is not zero. In practice, this definition is unfunctional, since at temperatures above 0 Kelvin most of the rotation-vibrational states have non zero energies. Therefore, a hot vibrational band or hot vibrational state is defined within the instant invention as an energy state in which one or more vibrations are thermally populated in the lower energy state. Since thermal population of vibrations is present at room temperature and the population property is given by the Boltzmann distribution, vibrations above 2400 cm⁻¹ have a negligible probability of being thermally populated. Thus, thermal population at temperatures around room temperature is generally limited to vibrations below 2400 cm⁻.

In an embodiment, the hot band chosen for obtaining the first absorption-related parameter has an absorption of 2400 cm⁻¹ or less, in particular 2300 cm⁻¹ or less, in particular 2200 cm⁻¹ or less, in particular 2100 cm⁻¹ or less, in particular 2000 cm⁻¹ or less, in particular 1900 cm⁻¹ or less, in particular 1800 cm⁻¹ or less, in particular 1700 cm⁻¹ or less, in particular 1600 cm⁻¹ or less, in particular 1500 cm⁻¹ or less, in particular 1400 cm⁻¹ or less, in particular 1300 cm⁻¹ or less, in particular 1200 cm⁻¹ or less, in particular 1100 cm⁻¹ or less, in particular 1000 cm⁻¹ or less, in particular 900 cm⁻¹ or less, in particular 800 cm⁻¹ or less, in particular 700 cm⁻¹ or less, in particular 600 cm⁻¹ or less, in particular 500 cm⁻¹ or less, in particular 400 cm⁻¹ or less. In an embodiment, the hot band has an absorption in a range between 400 cm⁻¹ and 2400 cm⁻¹ or in any other range that can be built up from the before-mentioned maximum absorptions (e.g., 500 cm⁻¹ to 2300 cm⁻¹ etc.).

A rotation-vibrational transition from this state to a higher energy state, leading to infrared absorption, changes the rotational quantum number and another vibrational state. Typically, the vibrational state that is changed upon light absorption is not the thermally populated vibration. Nevertheless, Q-band transitions could also occur.

The first infrared absorption band and the second infrared absorption band can generally be due to vibrational mode. A vibrational mode is, e.g., a symmetric stretching mode, an asymmetric stretching mode, a scissoring (bending) mode, a rocking mode, a wagging mode or a twisting mode (the four latter vibrations are also referred to as deformation modes). Depending on its structure, a molecule can generally vibrate in all of the before-mentioned modes. Generally, a certain mode causes upon excitation by infrared light one or more absorption bands in an infrared spectrum. Choosing different vibrational modes of the considered absorption bands means that one absorption band is, e.g., caused by excitation of a symmetric stretching mode and the other is, e.g., caused by excitation of a bending mode of the gas the temperature of which is to be determined. Any combinations of different vibrational modes underlying the observed absorption bands are possible. The temperature dependence of absorption bands caused by excitation of different modes differs from each other.

Excitation of hot bands are characterized by transitions from a first state to a second state, wherein neither the first state nor the second state corresponds to the ground state of the respective vibrational mode. Expressed in other words, hot bands arise from a state containing a thermal population of another vibrational mode; this state comprises additionally excited stretching and/or deformation vibrations. Hot bands show significantly higher temperature dependence than usual infrared absorption bands. However, their population density is smaller than that of usual infrared absorption bands. Due to their different origin in terms of the underlying vibrational mode(s), different hot bands regularly have different temperature dependencies.

The detected rotational transitions are preferably rotational transitions of different transition series. This means that their initial states differ from each other in at least one quantum number that is not changed upon light absorption. To give an example, the infrared light absorption could evoke in case of a first detected vibrational transition an increase of the quantum number of the asymmetric stretching vibration from 0 to 1 and at the same time an increase of the rotational quantum number from J to J+1. The quantum number of the bending vibration would, however, remain at 0. In case of a second detected vibrational transition from another transition series, the infrared light absorption would also evoke an increase of the quantum number of the asymmetric stretching vibration from 0 to 1 and at the same time an increase of the rotational quantum number from J′ to J′+1. In addition, the quantum number of the bending vibration would remain at 1. Such a constellation would correspond to a hot band since the bending vibration would already be excited in the initial state.

Even if the quantum number of the bending vibration would be increased due to light absorption from 0 to 1 of the first detected vibrational transition, the before-mentioned constellation would correspond to a hot band as long as the bending vibration is not 0 for the second detected vibrational transition.

In an embodiment, the precise determination of the absorption signal is favored to be done by fitting the absorption line as a spectral function. Therefore, the achieved precision is very often about 1*10⁻². Very fast measurements allow for a more precise determination of the signal, due to statistical averaging of individual measurements carried out in a certain time window. Statistical averaging can be performed, if the measurement time can be reduced, so that within the same measurement time for a state-of-the art experiment much more experiments can be performed. State-of-the art time ranges for an experiment to determine a spectrally resolved absorption is about 10 ms (Stepanov et al.), whereas very fast experiments with a very unusual technique using shock waves at reduced pressures combined with Doppler effect measurements (Arroyo et al.) can obtain about 200 μs.

The new approach of the instantly claimed invention allows for measuring the spectrally resolved absorption of a spectral window of smaller than 20 cm⁻¹, in particular smaller than 15 cm⁻¹, in particular smaller than 10 cm⁻¹, in particular smaller than 7 cm⁻¹, in particular smaller than 5 cm⁻¹, in particular smaller than 3 cm⁻¹, in particular smaller than 2 cm⁻¹, within 20 μs, in particular within 15 μs, in particular within 10 μs, in particular within 7 μs, in particular within 5 μs, in particular within 3 μs, in particular within 2 μs, and in particular even faster. In an embodiment, the spectral window is in range between 2 cm⁻¹ and 20 cm⁻¹, or within any other range that can be built up from the before-mentioned higher thresholds of window (e.g., 3 cm⁻¹ to 15 cm⁻¹, etc.). From the statistics this could result in a ten times higher accuracy than the fastest reported determination of a gas temperature according to prior art.

With a combination of shock wave gas preparation and Doppler effect measurement the gas temperature at a very low pressure of 0.046 atm was determined to an optimal sensitivity of ±2 K (Arroyo et al.). Such complicated schemes that require a well-defined closed sample cell are not suited to determine a flowing gas within an open sample cell. Moreover, the sequential process of measuring different gases would take seconds to prepare the next gas.

The new method according to the instantly claimed invention is capable of determining the temperature of a flowing gas with a better sensitivity only by a single infrared absorption measurement. In an embodiment of the claimed invention, there is no need for reference cells (as used in Stephanov et al.) and/or additional Doppler effect measurements (as used in Arroyo et al.).

The ultrafast spectral detection can be accomplished by an intra-puls sweep of the laser pulse in combination with ns electronic data read-out and a ns-infrared detector. With this technique a ⅓ K sensitivity is reached by an ultrafast single measurement using a pair of rotation-vibrational transitions within 2 cm⁻¹ (see FIG. 6) with anti-temperature and super-temperature dependence. This determination can be performed without knowledge of the pressure, without knowledge of the concentration, without knowledge of the gas composition, without fixed sample volume, without reference cell, and/or without a static gas sample during measurement.

In contrast to state-of-the-art techniques, where the sample cell has to be emptied, refilled, measured, and emptied again, i.e. a sequential method, our new method determines the temperature in a multi-parallel way. All multiple processes typically performed sequential, take place at the same time. This is a real-time determination. Nevertheless, a more precise determination is possible with the multi-parallel method according to an embodiment of the instantly claimed invention. Relative temperature changes of 10‰ and better, in particular 8‰ and better, in particular 5‰ and better, can be detected.

As outlined above, the method is not only suited to detect the temperature of the gas, but also to detect temperature changes in the gas over time.

Preferably, Fourier transform infrared (FTIR) spectroscopy or laser infrared spectroscopy is used as infrared technique. However, the method also works with other infrared techniques since it makes use of fundamental physical properties of the gas to be examined.

Infrared-active gases are all gases that are composed of more than one atom and that are composed not only of two identical atoms (e.g., O₂, N₂ and Cl₂ are not infrared active since there is no dipole change upon excitation of a vibrational mode of those gases). CO₂ is an example of an infrared active gas.

In an embodiment, the gas is static or flowing in an unspecified manner, when the method is carried out. The flow can be erratic, dynamic, regular, irregular, discontinuous or pulsed. The only restriction for space and time of the static or flowing gas is that the radiation has to pass the gas.

In another embodiment, the gas is flowing through a measurement device (or more precisely: through a measurement chamber of a measurement device) when the method is carried out. Thus, the method is well suited to determine the temperature of the gas by a flow-through measurement. The instantly claimed method can be well combined with other methods that analyze the gas in flow-through. A gas flow through the measurement device means that a volume of the sample gas at a defined site of a measurement chamber of the measurement device changes with a velocity being higher than 0 liters per minute (l/min).

In an embodiment, the gas is flowing through the measurement device (or more precisely: through a measurement chamber of the measurement device) with a velocity of 0.05 l/min or faster, in particular of 0.1 l/min or faster, in particular of 0.2 l/min or faster, in particular of 0.5 l/min or faster, in particular of 1.0 l/min or faster, in particular of 2.0 l/min or faster, in particular of 0.05 l/min to 5.0 l/min and very particular of 5.0 l/min or faster.

While the instantly claimed method is suited for the temperature determination of all infrared active gases, the gas is, in an embodiment, a component of a breathing gas exhaled by a human or animal. Usually, the breathing gas exhaled by a human or animal also contains infrared inactive gases like oxygen or nitrogen. The animal is preferably a mammal, in particular a primate, a rodent, an even-toed ungulate, an odd-toed ungulate or a carnivore.

In another embodiment, the gas is a gas in a combustion process (like in a motor vehicle or in a turbine, either before the combustion process or after the combustion process), a gas in an industrial biological process (like in a biogas plant), a gas in an industrial chemical process (like in a synthesis process in chemical industry) or a gas in a streaming surveillance process (like in gas pipelines or gas gathering facilities).

In an embodiment, at least one of the first absorption-related parameter and the second absorption-related parameter comprises an absorption, a set of spectrally resolved absorptions, a linewidth, a set of spectrally resolved linewidths, values of a mathematic function obtained on the basis of measured values and/or an area under a curve of the respective infrared absorption band. Thus, the first absorption-related parameter and the second absorption-related parameter can be either directly measured values or calculated values. They can have the same or a different nature (e.g., the first absorption-related parameter can be set of spectrally resolved absorptions and the second absorption-related parameter can be the linewidth, or both absorption-related parameters can be values of a mathematic function).

A set of spectrally resolved absorptions can also be referred to as spectrum. Thus, it is within the scope of the claimed method that a spectrum over a specific spectral range is measured and then used for the further steps of the method.

In an embodiment, the spectral range of the infrared light radiated onto the gas can, e.g., be a range of 800 to 4000 cm⁻¹, in particular of 900 to 3000 cm⁻¹, in particular of 1000 to 2500 cm⁻¹, in particular of 1200 to 2400 cm⁻¹, in particular of 1300 to 2300 cm⁻¹, in particular of 1500 to 2200 cm⁻. A range of 2200 to 2400 cm⁻¹ is particularly preferred.

In an embodiment, only a single absorption measurement is carried out to obtain the first absorption-related parameter and the second absorption-related parameter or value or set of values from which the first absorption-related parameter and the second absorption-related parameter can be calculated. This significantly increases the speed of the whole method while its accuracy is kept. E.g., two or more absorption signals can be measured in a time window of 10 ns to 10 ms, in particular of 100 ns to 1 ms, in particular of 500 ns to 50 μs and very particular of 750 ns to 10 μs.

In an embodiment, fast spectral measurements can be performed by at least one of the following options, wherein any combinations of these options are possible:
intra-pulse sweeping: within a nanosecond or microsecond laser pulse the spectral range is shifted continuously;
scanning a laser with two spectral modes/regions: lasers can be manufactured with different spectral output regions;
using two different lasers: two or more lasers with different wavelengths can be used simultaneously;
using two different laser sources without spectral scanning by detection of the maximum absorption of specific peaks from transitions and/or hot transitions.
using an infrared detector with a response time faster than 100 ns
using an electronic data detection system faster than 100 ns

If the general composition of the measured gas as well as the pressure of the gas are known, it is fully sufficient to measure two spectral positions in order to determine the absorption, as long as the chosen absorption bands show a similar linewidth dependence on temperature at the two spectral positions.

To achieve a high accuracy of the claimed method, an influence on the linewidth of infrared absorption bands by pressure changes and/or fluctuation of gas contributions should, in an embodiment, not exceed 25%, in particular 10%, in particular 5%, in particular 2% and very particular 1% of relative linewidth variations (always in comparison to the initially measured linewidth).

If bigger relative changes of the linewidth are observed or in case of strong baseline variations or of overlaps with other absorption bands, measuring with spectral resolution and determining the absorption band profile becomes advisable or necessary for highly reliable and accurate results. In doing so, individual data points within the spectral region of the absorption band to be detected are detected. Afterwards, a model function is fitted to the detected data points. Subsequently, the areas under the respective model function curves is determined.

The spectral range emitted by the light source is automatically changed in case of quantum cascade lasers if they are operated in pulsed mode. Use of continuous wave (cw) lasers (e.g., interband cascade lasers, ICLs) is also possible. In case of QCLs one can take advantage of the so-called intra-pulse sweep. The intra-pulse sweep arises due to a heating of the laser medium during a pulse. By favorably choosing the spectral range of the QCL, the spectral drift resulting from the intra-pulse sweep is already sufficient to detect an infrared spectrum of the desired absorption bands. In such a case, the duration of a measurement is as low as approximately 100 ns. Thus, the temperature or the temperature change can be determined by measuring suited vibrational transitions of a gas or a gas mixture within, e.g., 1 μs with an accuracy as indicated below.

In an embodiment, a model function is fitted to measured absorption values of the first infrared absorption band and/or of the second infrared absorption band to obtain the first absorption-related parameter and the second absorption-related parameter. Such a fitting of a model function to measured values further increases the accuracy of the claimed method since noise of the measured values can be effectively reduced or suppressed by using a suited fitting model. While the certainty of a fitted curve will increase with the quality of the underlying values to be fitted, very reliable results could already obtained by using a single absorption spectrum as starting point for a subsequent curve fitting. If fast spectral measurements are done (e.g. as outlined above), a higher number of measurements can be averaged without significant time delay so that an even more precise temperature determination is possible.

In an embodiment, the determination of the temperature is carried out in a time-resolved manner. In doing so, temperature changes over time within μs to ms of the analyzed gas can be detected.

In an embodiment, the method is carried out in 5 seconds or less, in particular within 2 seconds or less, in particular within 1 second or less, in particular within 750 ms or less, in particular within 1 ms or less, wherein a time window of 500 ns to 5 s, in particular of 750 ns to 2 s, in particular of 500 ns to 5 μs is particularly preferred. Thus, the claimed method can also be denoted as ultrafast optical temperature determination of an infrared active gas or gas mixture.

In an embodiment, the temperature or temperature change is determined with an accuracy of 5° C. or better, in particular of 2° C. or better, in particular of 1° C. or better, in particular of 0.5° C. or better, in particular of 0.3° C. or better, in particular of 0.2° C. or better, in particular of 0.1° C. or better and very particular of 0.01° C. or better.

In an embodiment, the concentration of the gas is additionally determined. This can be done by using equation 6. Here, the dimensions of the sample chamber and the volume of the measured gas have to be considered. Thereby, the method allows for an exact concentration determination of the gas being able to detect the concentration with an accuracy of with an accuracy of 1% per volume or better, in particular of 0.1% per volume or better, in particular of 0.01% per volume or better. Preferably, relative concentration changes can be detected with an accuracy of 10⁻² or better, in particular of 10⁻³ or better, in particular of 10⁻⁴ or better. If the gas flow rate is known or additionally determined (e.g. by using a spirometer), the total gas amount of a certain gas species in an analyzed gas mixture can be exactly determined.

In an embodiment, the first infrared absorption band and the second infrared absorption band are chosen such that the absorption of one of the first infrared absorption band and the second infrared absorption band increases with increasing gas temperature (super-temperature dependence), whereas the absorption of the other of the first infrared absorption band and the second infrared absorption band decreases with increasing gas temperature (anti-temperature dependence). Such a temperature dependence in the opposite direction further increases the accuracy of the claimed method since subtle temperature differences result in comparably high deviations of the ratio used to determine the temperature of the gas.

In an embodiment, the first infrared absorption band has a first medium (or average or median or center) position and the second infrared absorption has a second medium (or average or median or center) position, wherein a distance between the first medium position and the second medium position is between 0.5 cm⁻¹ and 1000 cm⁻¹. In order to avoid strongly overlapping signals it is favorable to measure at low pressures or in spectral regions where the overall density of gas absorption signals is low (for example between 3000 cm⁻¹ and 2350 cm⁻¹).

In an embodiment, a single laser is used as light source, wherein the laser can be tuned such that it can measure both the first medium position and the second medium position. Preferably, the tunability of the laser is in a range of between 0.5 cm⁻¹ and 60 cm⁻¹, in particular at or around 1 cm⁻¹, 2 cm⁻¹, 6 cm⁻¹ or 20 cm⁻¹ or in any range between these values.

It is also possible to use two light sources and two detectors, since an according detection can be accomplished within the response time of the detectors, lying within the nanosecond range.

All embodiments disclosed herein can be combined in any desirable manner.

### BRIEF DESCRIPTION OF THE DRAWINGS

Aspects of the instantly claimed invention will now be explained in more detail with reference to the accompanying figures and according embodiments.

FIG. 1 shows a rotation-vibrational spectrum of ¹²CO₂ and ¹³CO₂.

FIG. 2 shows a graphical depiction of the rotation-vibration absorption maxima as function of the rotational quantum number.

FIG. 3 shows a graphical depiction of the temperature dependence of the rotation-vibrational absorption spectrum of the CO₂ asymmetric stretching band.

FIG. 4 shows a graphical depiction of the intensity change in dependence on the rotational quantum number.

FIG. 5 shows a rotation-vibrational spectrum of ¹²CO₂ and ¹³CO₂ in exhaled breath of two consecutive breaths.

FIG. 6 shows calculated infrared absorption spectra of ¹²CO₂ in dependence on the temperature.

### DETAILED DESCRIPTION

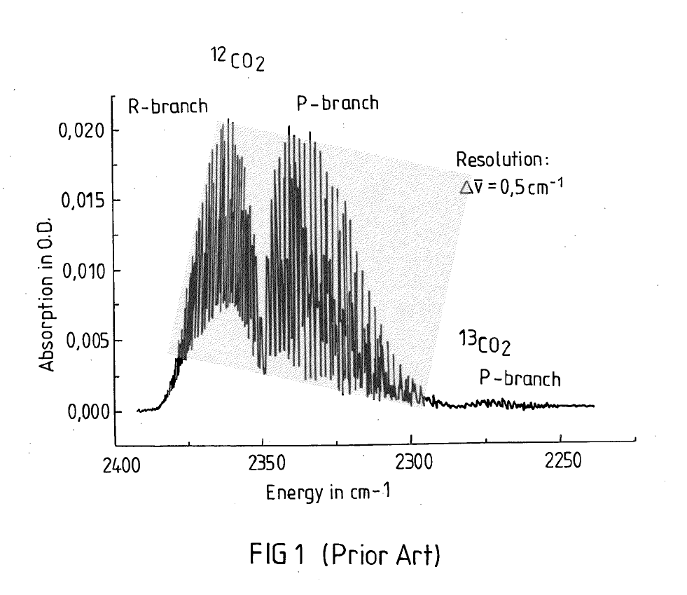

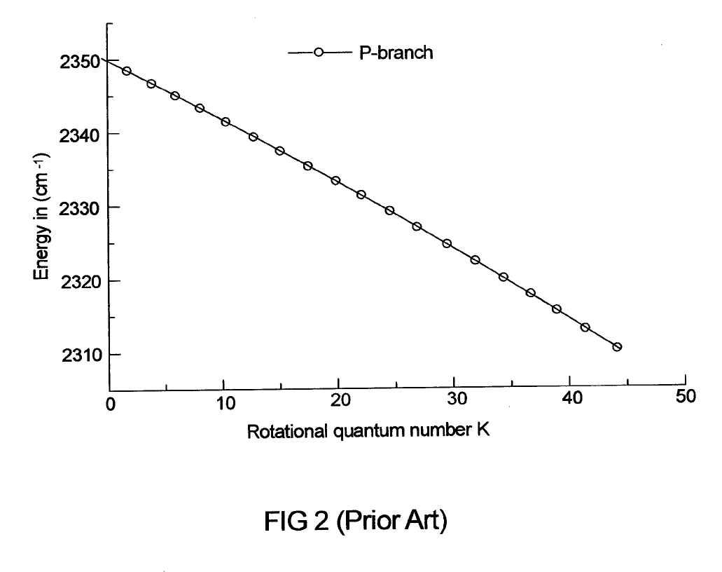

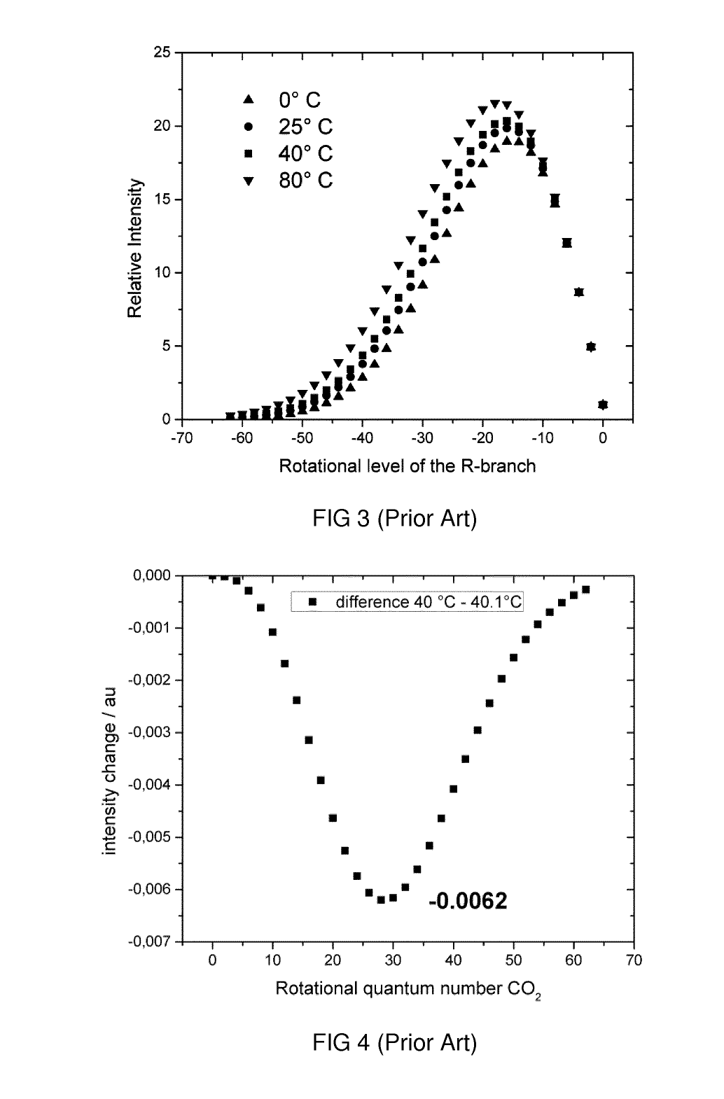

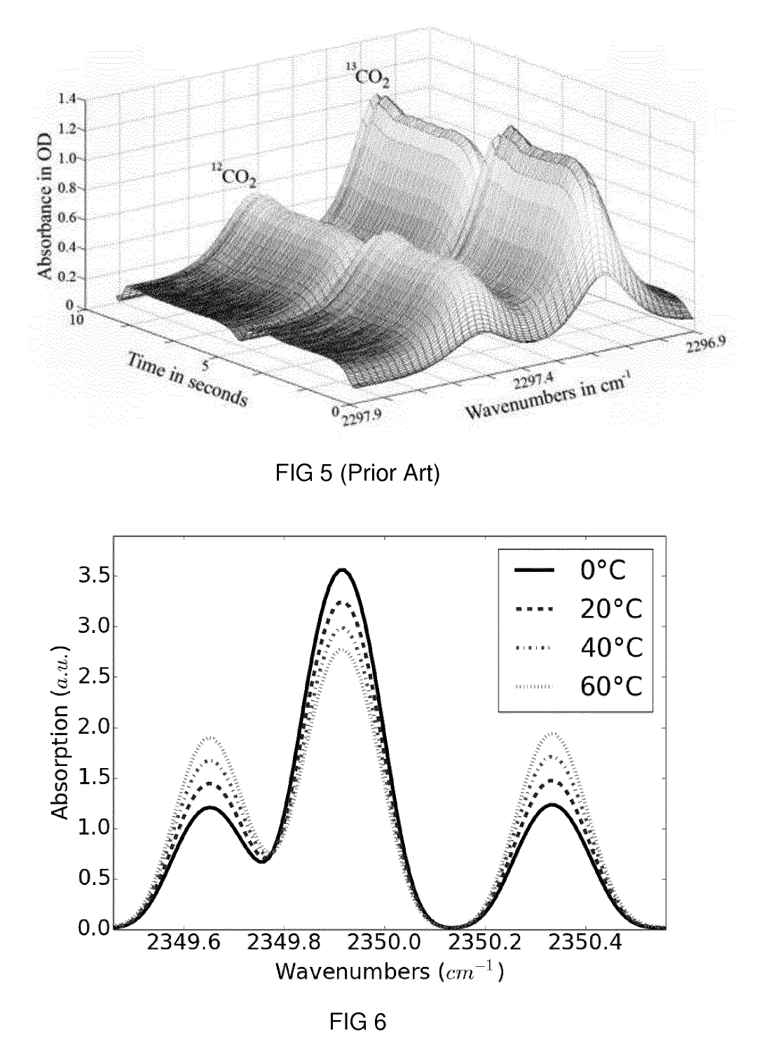

FIGS. 1 to 5 represent prior art and have already been discussed in the introductory part of the description to allow for a better understanding of the problem underlying the instant invention and for solution to which a person skilled in the art might come without knowledge of the instant invention.

FIG. 6 will now be explained with respect to an embodiment of the instant invention.

As explained above (cf. equation 1), thermal energy of 204 cm⁻¹ is available for molecules at room temperature. Regarding rotation, many molecules are therefore already in excited states (hot states). These states are populated according to the Boltzmann distribution.

If one now looks to the ratio of at least two absorption bands of the same molecule that show a differing temperature dependence, the temperature of the molecule can be directly and accurately determined from this ratio.

The accuracy can be even increased when looking at hot bands that can be considered as two-times temperature dependent. On the one hand, the overall absorption band of a vibrational transition shows a changing (in particular an increasing) infrared absorption with increasing temperature. On the other hand, the individual absorption bands (which are sometimes also referred to as absorption lines) that make up the overall absorption band change their strength with changing temperature.

Both the overall absorption band and the individual absorption bands or absorption lines are encompassed by the term “absorption band” as used herein.

In the present embodiment, two or more of the individual absorption bands of ¹²CO₂ are considered for calculating a ratio of their areas (Aₓ) as absorption-related parameter. If two bands are considered, the ratio can be A₁:A₂ or A₂:A₁. If three lines are considered, the ratio can be, e.g., A₁:A₂:A₃ or A₁:A₂ or A₁:A₃ or A₂:A₃. Preferably, one chooses those lines for consideration that have the most differing temperature dependence. Since these absorption bands often occur in the respective spectrum very close to each other, it is possible to measure them in a very short time interval. Preferably, adjacent absorption bands are used.

FIG. 6 shows a simulation of the absorption of ¹²CO₂ at a concentration (c) of 3% per volume under normal pressure and at a pathlength (d) of 1 mm (cf. in this respect equation 6). The temperature was varied between 273 K (0° C.) and 333 K (60° C.) for the individual simulations.

The absorption of the middle (strongest) absorption band (R-branch no. 0) decreases upon increasing the temperature to 60° C. onto approximately 78% of the initial value calculated for 0° C. (anti-temperature dependence). The absorption of the other absorption bands (hot bands with R-branches no. 17 and 18) increase by increasing the temperature to 60° C. onto approximately 158% of the initial value calculated for 0° C. (super-temperature dependence). By calculating the areas under the curves of the middle absorption band and either of the side bands (these areas are an example of an absorption-related parameter) and by subsequently calculating the ratio of the areas, it becomes apparent that the ratio of the areas changes by about 3.3% per Kelvin.

Thus, this spectral range is suited to detect temperature differences or deviations of less than ⅓ K in an ultrafast manner by carrying out a single measurement (without averaging several measurements) and a subsequent fit of a model function to the measured data.

1. A method for determining the temperature of an infrared-active gas by means of infrared-spectroscopy of rotational-vibrational band transitions, comprising:
radiating infrared light in a spectral range of 700 cm⁻¹ to 5000 cm⁻¹ originating from an infrared light source onto a gas,
obtaining a first absorption-related parameter originating from measuring a first infrared absorption band of the gas, wherein the first infrared absorption band is a hot band being caused by thermal population of at least one vibrational mode of the gas,
obtaining a second absorption-related parameter originating from measuring a second infrared absorption band of the gas, and
calculating a ratio between the first absorption-related parameter and the second absorption-related parameter,
wherein the ratio is used to determine the temperature of the gas, wherein the ratio has a relative change of at least 0.5% per Kelvin temperature difference of the gas.

2. The method according to claim 1, wherein the first absorption band has a super-temperature dependence and in that the second absorption band has an anti-temperature dependence.

3. The method according to claim 1, wherein the gas is flowing through a measurement device when the method is carried out.

4. The method according to claim 1, wherein the gas is flowing through the measurement device with a velocity of 0.05 liters per minute or faster.

5. The method according to claim 1, wherein the gas is a component of an exhaled gas from a human or an animal, a gas in a combustion process, a gas in an industrial biological process, a gas in an industrial chemical process or a gas in a streaming surveillance process.

6. The method according to claim 1, wherein at least one of the first absorption-related parameter and the second absorption-related parameter comprises an absorption, a set of spectrally resolved absorptions, a linewidth, a set of spectrally resolved linewidths, values of a mathematic function obtained on the basis of measured absorption values and/or an area under a curve of the respective infrared absorption band.

7. The method according to claim 1, wherein only a single absorption measurement is carried out.

8. The method according to claim 1, wherein a model function is fitted to measured values of the first infrared absorption band and/or the second infrared absorption band.

9. The method according to claim 1, wherein the determination of the temperature is carried out in a time-resolved manner.

10. The method according to claim 1, wherein the method is carried out in 5 seconds or less.

11. The method according to claim 1, wherein the concentration of the gas is additionally determined.

12. The method according to claim 1, wherein the first infrared absorption band and the second infrared absorption band are chosen such that the absorption of one of the first infrared absorption band and the second infrared absorption band increases with increasing gas temperature, whereas the absorption of the other of the first infrared absorption band and the second infrared absorption band decreases with increasing gas temperature.

13. The method according to claim 1, wherein the first infrared absorption band has a first medium position and the second infrared absorption has a second medium position, wherein a distance between the first medium position and the second medium position is between 0.5 cm⁻¹ and 1000 cm⁻¹.

14. The method according to claim 13, wherein a laser is used as light source, wherein the laser can be tuned such that it can measure both the first medium position and the second medium position.
